(19) United States
(12) Patent Application Publication
(10) Pub. No.: US 2025/0244585 A1
(43) Pub. Date: Jul. 31, 2025

(54) VIRTUAL IMAGE DISPLAY DEVICE AND OPTICAL UNIT

(71) Applicant: SEIKO EPSON CORPORATION, Tokyo (JP)

(72) Inventors: Katsutoshi INOMOTO, Shiojiri-shi (JP); Takashi Takeda, Suwa-shi (JP); Mitsutaka Ide, Shiojiri-shi (JP); Masayuki Takagi, Azumino-shi (JP)

(73) Assignee: SEIKO EPSON CORPORATION, Tokyo (JP)

(21) Appl. No.: 19/041,691

(22) Filed: Jan. 30, 2025

(30) Foreign Application Priority Data
Jan. 31, 2024 (JP) 2024-012623

(51) Int. Cl. G02B 27/01; G02B 5/30

(52) U.S. Cl. CPC G02B 27/0172; G02B 5/3016

(57) ABSTRACT

A virtual image display device includes: a display including a pixel region that emits image light of right circularly polarized light, and configured to transmit external light, a first optical member having a flat surface on the display side and including a semi-transmissive reflective optical surface having power inside thereof, a wave plate being a quarter-wave plate configured to convert a polarization state of the image light passing through the first optical member to be vertically polarized being linearly polarized, and a second optical member including a polarization reflective layer that reflects the image light passing through the wave plate, wherein an imaging optical system in which the first optical member, the wave plate, and the second optical member are combined does not substantially have power for left circularly polarized light being a polarized component of the external light passing through a light transmission region of the display.

The present application is based on, and claims priority from JP Application Serial Number 2024-012623, filed Jan. 31, 2024, the disclosure of which is hereby incorporated by reference herein in its entirety.

### BACKGROUND

### 1. Technical Field

The present disclosure relates to a virtual image display device and an optical unit that enable observation of a virtual image, and particularly to a virtual image display device or the like of a see-through type that enables visual recognition of an external world image.

### 2. Related Art

As a virtual image display device, one has been known that includes an image element configured to display an image, a first optical unit disposed at a position where image light is extracted, a second optical unit disposed on the image element side with respect to the first optical unit, a Fresnel-type half mirror formed at a bonding portion between the first optical unit and the second optical unit, and a transmission/reflection selection member provided on a light emitting side of the first optical unit and configured to selectively transmit or reflect light depending on a polarization state of the light (JP 2020-24246 A).

Although see-through distortion can be eliminated in the above device, when a reduction in thickness of an imaging optical system disposed between the image element and an eye is attempted, there is a problem that power becomes insufficient and high resolution cannot be obtained only by the Fresnel-type half mirror, and color unevenness or the like is likely to occur around an angle of view.

### SUMMARY

A virtual image display device and an optical unit in an aspect of the present disclosure include, in an order from an external world, a display including a pixel region that emits circularly polarized image light, and configured to partially transmit external light, a first optical member having a flat surface on the display side and including a semi-transmissive reflective optical surface having power inside thereof, a wave plate configured to convert a polarization state of the image light passing through the first optical member to be linearly polarized or circularly polarized, and a second optical member including a polarization reflective layer that reflects the image light passing through the wave plate, wherein an imaging optical system in which the first optical member, the wave plate, and the second optical member are combined does not substantially have power for a polarized component of the external light passing through a light transmission region of the display.

### BRIEF DESCRIPTION OF THE DRAWINGS

FIG. 1 is an external perspective view for describing a mounted state of a virtual image display device of a first embodiment.

FIG. 2 is a conceptual side view for describing an optical structure of a display optical system.

FIG. 3A is a partially enlarged side view for describing an example of a specific structure of a first display.

FIG. 3B is a partially enlarged rear view for describing the example of the specific structure of the first display.

FIG. 3C is a diagram for describing a modification of the first display of a device illustrated in FIG. 2.

FIG. 4 is a conceptual diagram for describing a polarization state of image light or the like in the device illustrated in FIG. 2.

FIG. 5 is a conceptual diagram for describing a polarization state in the modification illustrated in FIG. 3C.

FIG. 6 is a conceptual diagram for describing a polarization state in another modification.

FIG. 7A is a diagram for describing an optical structure of a virtual image display device of a second embodiment.

FIG. 7B is a partially enlarged view of a center of a first display optical system.

FIG. 8 is a conceptual side view for describing an optical structure of a virtual image display device of a third embodiment.

FIG. 9 is a conceptual diagram for describing a polarization state of image light or the like in the device illustrated in FIG. 8.

FIG. 10 is a diagram for describing a modification of the virtual image display device illustrated in FIG. 8.

FIG. 11 is a conceptual diagram for describing an optical structure of a virtual image display device of a fourth embodiment.

### DESCRIPTION OF EMBODIMENTS

### First Embodiment

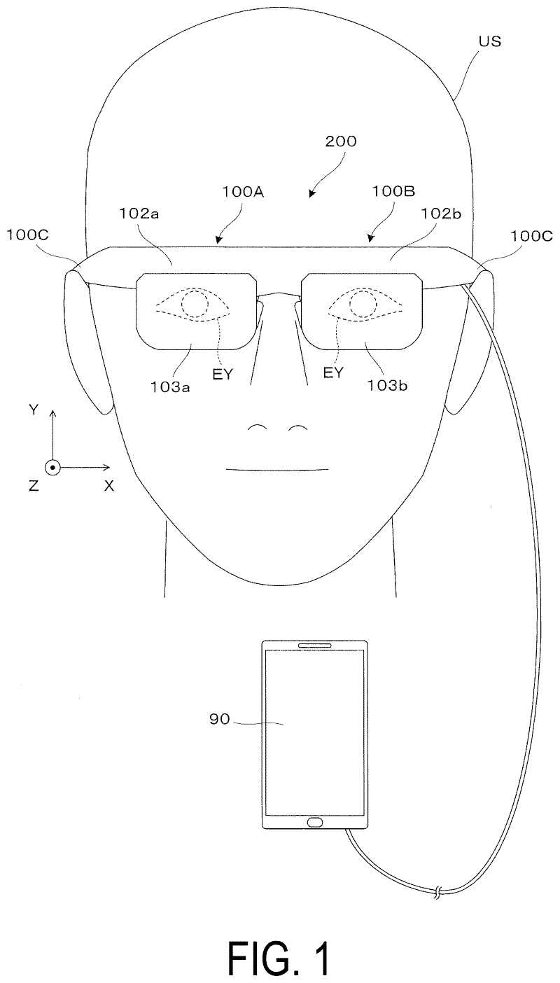

A first embodiment of a virtual image display device and the like according to the present disclosure will be described below with reference to FIGS. 1 to 4.

FIG. 1 is a diagram for describing a mounted state of a head-mounted virtual image display device (hereinafter, also referred to as a head-mounted display or an “HMD”) 200, and the HMD 200 causes an observer or wearer US, who is wearing the HMD 200, to recognize an image as a virtual image. In FIG. 1 and the like, X, Y, and Z represent a rectangular coordinate system. A +X direction corresponds to a lateral direction in which both eyes EY of the observer or the wearer US, who wears the HMD 200, are arranged. A +Y direction corresponds to an upper direction perpendicular to the lateral direction from the viewpoint of the wearer US in which both the eyes EY are arranged. A +Z direction corresponds to a forward direction or a front side direction from the viewpoint of the wearer US. The ±Y direction is parallel to a vertical axis or a vertical direction.

The HMD 200 includes a first virtual image display device 100A, which is for a left eye and is of a direct virtual image type, a second virtual image display device 100B, which is for a left eye and is of a direct virtual image type, a pair of temple type support devices 100C that support these virtual image display devices 100A and 100B, and a user terminal 90 that is an information terminal. The first virtual image display device 100A alone functions as an HMD, and includes a first display driving unit 102a disposed at an upper portion, and a first combiner 103a having a shape of a spectacle lens and covering a front of an eye. Similarly, the second virtual image display device 100B alone functions as an HMD, and includes a second display driving unit 102b disposed at the upper portion, and a second combiner 103b having a shape of a spectacle lens and covering a front of an eye. The support devices 100C are mounting members mounted on a head of the wearer US, and support upper ends of the pair of combiners 103a and 103b via the display driving units 102a and 102b that are integrated in appearance. The first virtual image display device 100A and the second virtual image display device 100B are optically identical or left-right inverted, and a detailed description of the second virtual image display device 100B will thus be omitted.

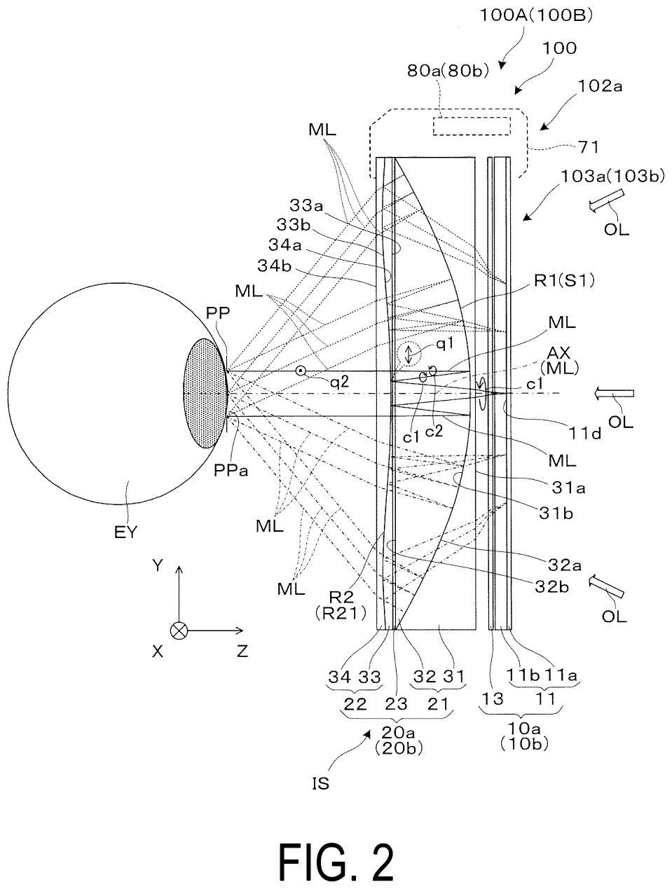

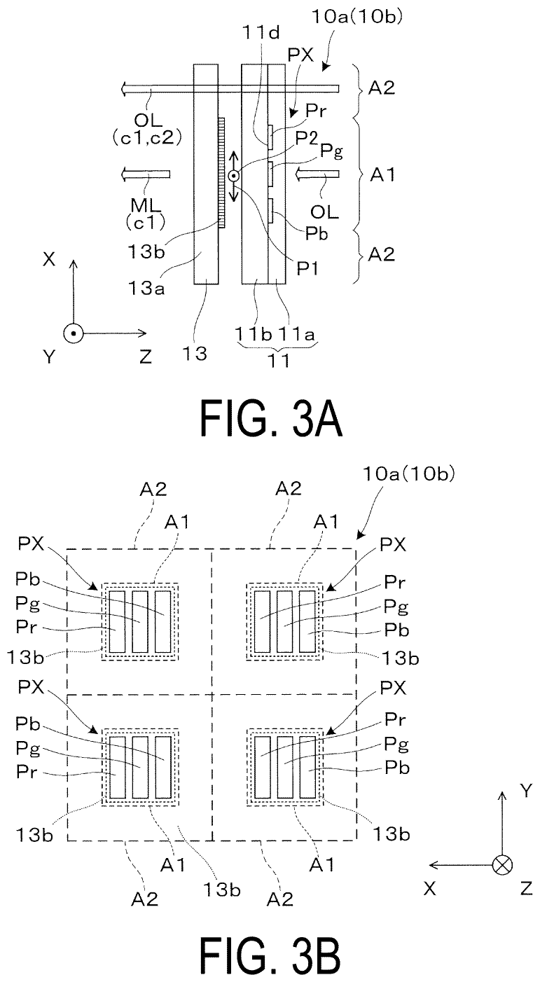

FIG. 2 is a side cross-sectional view for describing an internal structure of the first virtual image display device 100A. The first virtual image display device 100A includes a first display 10a, a first display optical system 20a, and a first circuit member 80a. Among them, the first display 10a emits circularly polarized image light ML. The first display optical system 20a is an imaging optical system IS that directly forms a virtual image without forming an intermediate image. The first display optical system 20a, that is, the imaging optical system IS includes a first optical member 21 including a reflective optical surface R1 having power inside thereof, a wave plate 23 that converts a polarization state of the image light ML to be linearly polarized or circularly polarized, and a second optical member 22 including a polarization reflective layer R2. That is, the first virtual image display device 100A includes, as optical elements, in an order from an external world, the first display 10a, the first optical member 21, the wave plate 23, and the second optical member 22. As will be described in detail below, the imaging optical system IS does not substantially have power for left circularly polarized light c2, which is a polarized component of external light OL passing through a light transmission region A2 (see FIG. 3A) of the display 10a or 10b. Here, “the imaging optical system IS does not substantially have power for a specific polarized component of the external light OL” means that power related to the specific polarized component of the external light OL is smaller than power related to the image light ML, and more specifically means that a focal distance related to the specific polarized component of the external light OL of the imaging optical system IS is, for example, from about 1 to 2 m to infinity.

Each of the first optical member 21 and the second optical member 22 emits the image light ML toward a pupil position PP or the eye EY via forward and backward optical paths formed by the reflective optical surface R1 and the polarization reflective layer R2, causes the external light OL to be transmitted as is, and to be incident on the pupil position PP. The first optical member 21 is a semi-transmissive reflective optical element, and functions as an optical element having positive power for the image light ML, by the reflective optical surface R1. The wave plate 23 is a quarter-wave plate. The second optical member 22 is a reflective polarizing element and functions as an optical element having positive or negative power for the image light ML, by the polarization reflective layer R2.

Although detailed description is omitted, the second virtual image display device 100B includes the second display 10b, a second display optical system 20b, and a second circuit member 80b. The second display 10b is similar to the first display 10a, the second display optical system 20b is similar to the first display optical system 20a, and the second circuit member 80b is similar to the first circuit member 80a. The second display optical system 20b includes the first optical member 21, the wave plate 23, and the second optical member 22.

Note that, in the first virtual image display device 100A, an optical device excluding the first circuit member 80a is referred to as an optical unit 100. Further, in the second virtual image display device 100B, an optical device excluding the second circuit member 80b is referred to as the optical unit 100.

In the first virtual image display device 100A, the first display 10a, for example, while emitting the image light ML being right circularly polarized light toward the first display optical system 20a, partially transmits the external light OL including components of left circularly polarized light.

FIGS. 3A and 3B are a partially enlarged side view and a partially enlarged rear view for describing an example of a specific structure of the first display 10a. Referring to FIG. 3A, the first display 10a has a structure in which a display panel 11 and a polarizing member 13 are laminated and integrated. Referring to FIG. 3B, the first display 10a individually includes quadrangular pixel regions A1 provided in a discrete arrangement and light transmission regions A2 having optical transparency. The pixel regions A1 correspond to pixels PX of the first display 10a, and are arrayed in a matrix along an XY plane. In other words, the pixel regions A1 are periodically and two-dimensionally arrayed with respect to a horizontal X direction and a longitudinal Y direction.

The display panel 11 is a self-luminous image light generating device. The display panel 11 includes a light modulation element 11a and a protective glass 11b. The display panel 11 is, for example, an organic electroluminescence (EL) display, and forms a color still image or moving image on a two-dimensional display surface 11d. The display panel 11 emits the image light ML toward the polarizing member 13 in units of the pixels PX corresponding to the pixel regions A1. The pixel PX includes sub-pixels Pr, Pg, and Pb corresponding to three colors of RGB. The light modulation element 11a has a light shielding property in the pixel region A1, prevents transmission of the external light OL, has optical transparency in the light transmission region A2, and allows transmission of the external light OL. The external light OL passes through the light transmission region A2 and thus passes through the imaging optical system IS without being affected by the pixel region A1. The display panel 11 is driven by the first circuit member 80a to perform display operation.

The polarizing member 13 includes a quarter-wave plate 13a, and a rectangular polarizing layer 13b provided on the display panel 11 side of the quarter-wave plate 13a. Although omitted in illustration, at the entire polarizing member 13, a large number of the polarizing layers 13b are arrayed in a matrix along the XY plane at positions of the pixel regions A1 so as to face the pixels PX. The polarizing layer 13b is configured to restrict transmitted light, that is, the image light ML, to a predetermined polarization direction, to be specific, to vertically polarized light P1 being polarized in a first polarization direction, and to block horizontally polarized light P2 being polarized in a second polarization direction orthogonal to the first polarization direction. The quarter-wave plate 13a is a plate-shaped member extending along the XY plane, and a fast axis or a slow axis is set in, for example, an intermediate direction between the X direction and the Y direction, and linearly polarized light passing through a polarizing layers 13b is converted into right-handed circularly polarized light c1. Here, the image light ML being circularly polarized means that when attention is paid to a vibration of an electric field component or a magnetic field component of the image light ML, a vibration direction thereof rotates at a frequency of the image light ML in a plane perpendicular to a traveling direction of the light, and amplitude is constant regardless of the direction. Right-handed circularly polarized light is one in which a vibration direction of an electric field component rotates clockwise when viewed from an observer standing facing in a direction in which a light beam approaches, and in left-handed circularly polarized light, the rotation is counterclockwise. However, in the present specification, as long as the image light ML mainly includes right-handed circularly polarized light, for example, even when linearly polarized light in a specific direction is included, such image light ML is assumed to be the right-handed circularly polarized light c1. Similarly, when the image light ML mainly includes left-handed circularly polarized light, such image light ML is assumed to be the left-handed circularly polarized light c2. In the present specification, the right-handed circularly polarized light c1 is also referred to as right circularly polarized light c1, and the left-handed circularly polarized light c2 is also referred to as left circularly polarized light c2.

Referring to FIG. 2, the first optical member 21 is a member having a parallel plate shape as a whole, and does not have power as a whole for transmitted light. In the first optical member 21, a first incident surface 31a on the display panel 11 side and a second emission surface 32b on the wave plate 23 side are parallel to each other and extend parallel to the XY plane. The first optical member 21 includes a first lens element 31 and a second lens element 32 that are joined to each other with the reflective optical surface R1 interposed therebetween. The first lens element 31 includes the first incident surface 31a being a flat surface and a first emission surface 31b being a continuously concave curved surface. In particular, the first emission surface 31b is a concave spherical surface or an aspherical surface. The second lens element 32 includes a second incident surface 32a being a continuously convex curved surface and the second emission surface 32b being a flat surface. Above the second incident surface 32a of the second lens element 32, the reflective optical surface R1 made of a single-layer or multilayer metallic film and having transparency is formed by vapor deposition or the like. The reflective optical surface R1 has the same shape as that of the second incident surface 32a. That is, the reflective optical surface R1 is a continuously curved optical surface S1, and is a spherical surface or an aspherical surface concave toward the second emission surface 32b. The reflective optical surface R1 partially transmits the image light ML emitted from the display panel 11 at a predetermined transmittance (specifically, for example, 50%) and partially reflects the image light ML, which is return light from the wave plate 23 and the second optical member 22, at a corresponding reflectance (specifically, for example, 50%). The first optical member 21 is like a joined lens having the continuous reflective optical surface R1 embedded inside thereof. The reflective optical surface R1 being of a semi-transmissive type means that, for example, a transmittance can be appropriately set in a rage of less than 100%, and a transmittance of the reflective optical surface R1 is normally set to be in a range of 30% to 70%, but is not limited thereto.

The first lens element 31 is formed from a plastic material or glass by a method such as molding, and the second lens element 32 is also formed from a plastic material or glass by a method such as molding. The first lens element 31 and the second lens element 32 have the same refractive index and are joined to each other using, for example, an adhesive having the same refractive index as the refractive index of the first lens element 31. The reflective optical surface R1 may be formed above the first incident surface 31a, and the first lens element 31 may be a cured plastic material filled between the second lens element 32 and the wave plate 23.

The wave plate 23 is a quarter-wave plate. The wave plate 23 is a member having a parallel plate shape as a whole, and does not have power as a whole for transmitted light. A fast axis or a slow axis of the wave plate 23 is set, for example, in an intermediate direction between the X direction and the Y direction perpendicular to an optical axis AX, and the wave plate 23 converts the image light ML being the right circularly polarized light cl emitted from the display panel 11 and passing through the first optical member 21 into vertically polarized light q1 being parallel to the longitudinal Y direction and linearly polarized. The wave plate 23 converts the image light ML reflected by the polarization reflective layer R2 of the second optical member 22 into the right circularly polarized light cl when the image light ML is transmitted toward the first optical member 21. When the image light ML, which is reflected by the polarization reflective layer R2 of the second optical member 22, reflected by the reflective optical surface R1 of the first optical member 21, and converted into the left circularly polarized light c2, is transmitted toward the second optical member 22, the wave plate 23 converts the image ML into the horizontally polarized light q2 being parallel to the X direction and linearly polarized.

The second optical member 22 is a member having a parallel plate shape as a whole, and does not have power as a whole for transmitted light. In the second optical member 22, a third incident surface 33a on the wave plate 23 side and a fourth emission surface 34b on the eye EY side are parallel to each other and extend parallel to the XY plane. The second optical member 22 includes a third lens element 33 and a fourth lens element 34 that are joined to each other with the polarization reflective layer R2 interposed therebetween. The third lens element 33 includes the third incident surface 33a being a flat surface and a third emission surface 33b being a continuously curved surface. In particular, the third emission surface 33b is an aspherical surface. The fourth lens element 34 includes a fourth incident surface 34a being a continuously convex curved surface and the fourth emission surface 34b being a flat surface. Above the third emission surface 33b of the third lens element 33, a reflective polarizer R21 such as a wire grid is formed as the polarization reflective layer R2 by vapor deposition, patterning using etching, or the like. The polarization reflective layer R2 is an aspherical surface having the same shape as that of the third emission surface 33b. The polarization reflective layer R2 reflects the image light ML transmitted through the reflective optical surface R1 and converted into the vertically polarized light q1 through the wave plate 23, and selectively transmits the image light ML being return light from the wave plate 23 and the first optical member 21 and converted into the horizontally polarized light q2. The second optical member 22 is like a joined lens having the continuous polarization reflective layer R2 embedded inside thereof.

The third lens element 33 is formed from a plastic material or glass by a method such as molding, and the fourth lens element 34 is also formed from a plastic material or glass by a method such as molding. The third lens element 33 and the fourth lens element 34 have the same refractive index and are joined to each other using, for example, an adhesive having the same refractive index as the refractive index of the third lens element 33. The third lens element 33 may be a cured plastic material filled between the fourth lens element 34 and the wave plate 23.

When the polarization reflective layer R2 is a wire-grid polarizing element, an in-plane distribution of an extinction ratio increases as a curvature of the polarization reflective layer R2 increases, and thus, for example, a radius of curvature is desirably equal to or greater than 40 mm.

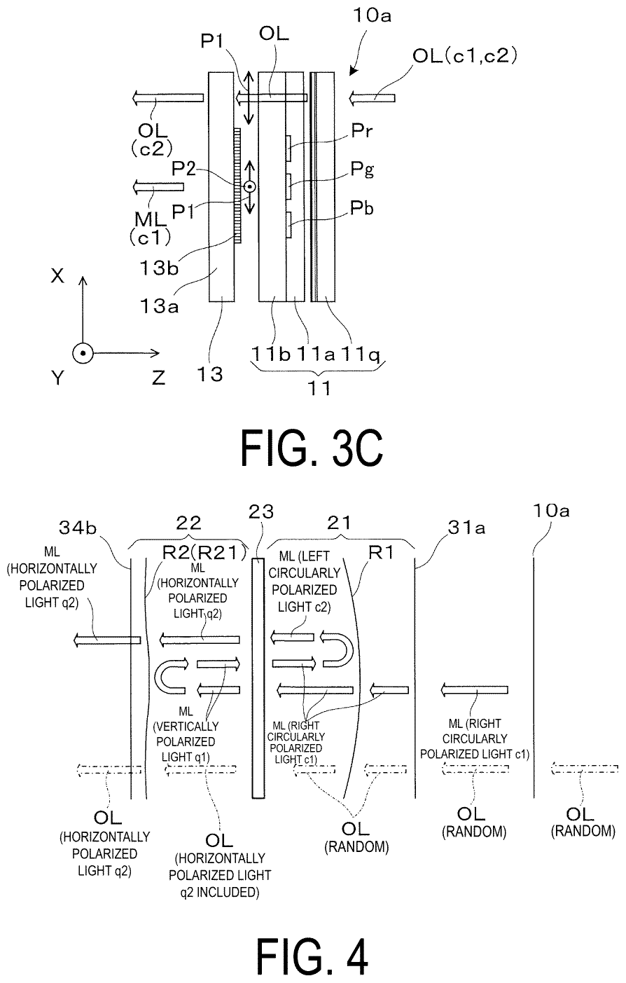

Referring to FIG. 4, a polarization state of the image light ML or the like in the first virtual image display device 100A illustrated in FIG. 2 will be described. The image light ML from the first display 10a is the right circularly polarized light c1, incident on the first optical member 21, partially transmitted through the reflective optical surface R1, and incident on the wave plate 23 being a quarter-wave plate from a forward direction. The image light ML passing through the wave plate 23 is converted into the longitudinal vertical polarized light q1, incident on the second optical member 22, mostly reflected by the polarization reflective layer R2, and incident on the wave plate 23 again. The image light ML passing through the wave plate 23 from a reverse direction is converted into the right circularly polarized light c1, incident on the first optical member 21, and partially reflected by the reflective optical surface R1. The image light ML reflected by the reflective optical surface R1 is converted into the left circularly polarized light c2 and incident on the wave plate 23 being a quarter-wave plate, from the forward direction. The image light ML passing through the wave plate 23 is converted into the lateral horizontally polarized light q2, incident on the second optical member 22, and passes through the polarization reflective layer R2. The image light ML emitted outward the second optical member 22 is incident on the pupil position PP (see FIG. 2) at which the eye EY or a pupil of the wearer US is disposed.

The external light OL is randomly polarized, and the external light OL transmitted through the light transmission region A2 in the first display 10a includes the right circularly polarized light c1 and the left circularly polarized light c2. The right circularly polarized light cl emitted from the light transmission region A2 of the first display 10a is incident on the first optical member 21, partially transmitted through the reflective optical surface R1, and incident on the wave plate 23. The external light OL passing through the wave plate 23 is converted into the lateral horizontally polarized light q2, incident on the second optical member 22, and passes through the polarization reflective layer R2. As described above, the specific component of the external light OL passes through the first display optical system 20a including the optical members 21, 22, and the like, but the first display optical system 20a does not cause a lens action on the external light OL.

In the first virtual image display device 100A illustrated in FIG. 2, a thickness of the imaging optical system IS, that is, a distance from the first incident surface 31a of the first optical member 21 to the fourth emission surface 34b of the second optical member 22 is equal to or less than 7 mm. Note that an FOV (Field of View) of the imaging optical system IS is set to about 100° diagonally. By setting the thickness of the imaging optical system IS to be equal to or less than 7 mm, it is possible to reduce the virtual image display device, 100A, 100B, or the optical unit 100 in weight. In the imaging optical system IS, despite the thickness of equal to or less than 7 mm, a divergence state of the image light ML is adjusted with high accuracy by reflection at the reflective optical surface R1 and the polarization reflective layer R2, thus resolution can be enhanced and color unevenness can be reduced.

FIG. 3C is a diagram for describing a modification of the first display 10a illustrated in FIG. 2. In this case, in the first display 10a, the display panel 11 includes a polarizing element 11q, the light modulation element 11a, and the protective glass 11b in an order from the external world side. The polarizing region 11q is configured to restrict polarization to a direction different from the polarizing layer 13b of the polarizing member 13, to be specific, to the horizontally polarized light P2 being polarized in the second polarization direction, and to block the vertically polarized light P1 being polarized in the first polarization direction orthogonal to the second polarization direction.

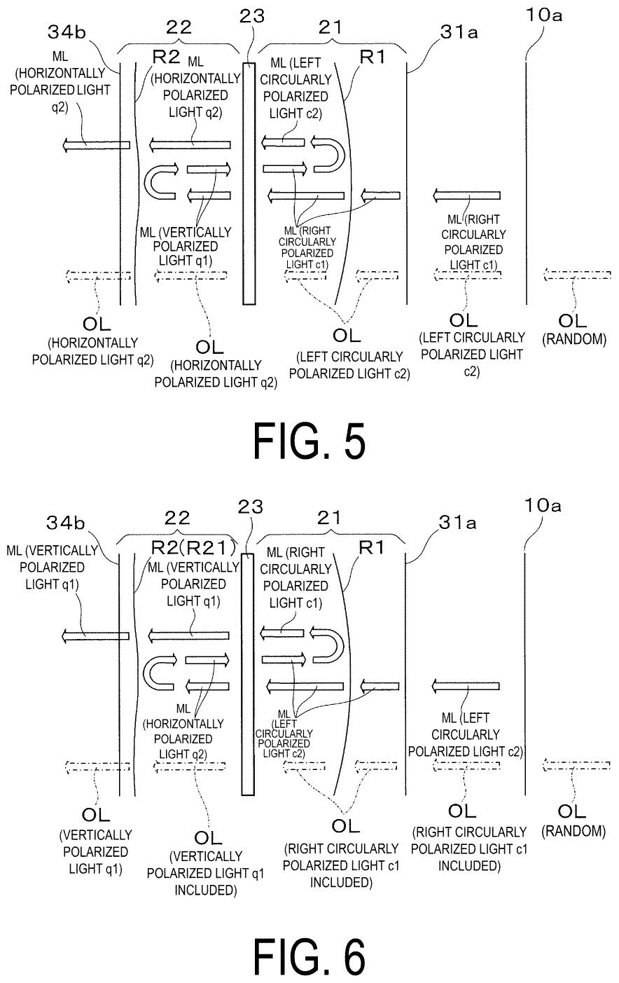

As illustrated in FIG. 5, by adding the polarizing element 11q to the display panel 11, the external light OL passing through the first optical member 21 of the first display 10a can be limited to only the left circularly polarized light c2, and it is possible to prevent the unnecessary external light OL from entering the first display optical system 20a.

In the above description, the displays 10a and 10b emit the image light ML being the right circularly polarized light c1, but the displays 10a and 10b may emit the image light ML being the left circularly polarized light c2. In this case, the polarization reflective layer R2 selectively reflects the horizontally polarized light q2.

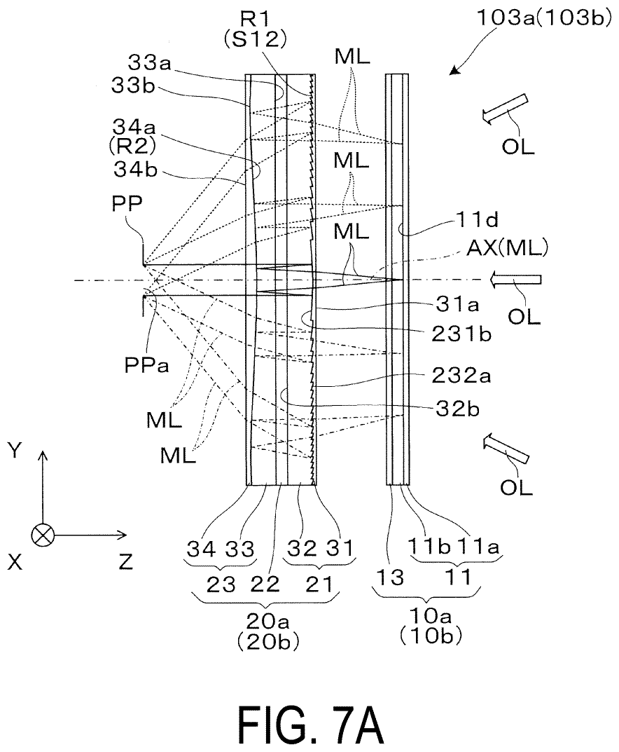

FIG. 6 is a diagram for describing a case where the first display 10a emits the image light ML being the left circularly polarized light c2. In this case, the image light ML being the left circularly polarized light c2 passing through the reflective optical surface R1 of the first optical member 21 passes through the wave plate 23 being a quarter-wave plate from the forward direction to become the horizontally polarized light q2 being linearly polarized and is reflected by the polarization reflective layer R2, and passes through the above wave plate 23 from a reverse direction to become the original left circularly polarized light c2 and is partially reflected by the reflective optical surface R1. The image light ML reflected by the reflective optical surface R1 becomes the reversed right circularly polarized light c1, passes through the above wave plate 23 from the forward direction to become the vertically polarized light q1 being linearly polarized in an intersecting direction, and passes through the polarization reflective layer R2. On the other hand, the right circularly polarized light c1 of the external light OL is incident on the first optical member 21, partially transmitted through the reflective optical surface R1, and incident on the wave plate 23. The external light OL passing through the wave plate 23 is converted into the vertically polarized light q1, incident on the second optical member 22, and passes through the polarization reflective layer R2.

The display panel 11 is not limited to a self-luminous organic EL display or the like, and may be a light modulation type liquid crystal display. When the display panel 11 is a liquid crystal display, for example, it is conceivable that a structure is adopted in which a light-guiding plate is disposed on the external world side of the display panel 11 so that illumination light is supplied from an end portion of the light-guiding plate.

The display panel 11 may be one that repeats display operation at high speed. In this case, the display panel 11 can be, for example, configured as a transmissive device in the pixel region A1, and by transmitting the external light OL at the time of non-display during display operation, thereby enabling see-through viewing.

The virtual image display device 100A, 100B, or the optical unit 100 of the first embodiment described above includes, in an order from the external world, for example, the display 10a or 10b including the pixel region A1 that emits the image light ML being the right circularly polarized light c1, and configured to partially transmit the external light OL, the first optical member 21 having a flat surface on the display 10a or 10b side and including the semi-transmissive reflective optical surface R1 having power inside thereof, the wave plate 23 being a quarter-wave plate and configured to convert a polarization state of the image light ML passing through the first optical member 21 into the vertically polarized light q1 being linearly polarized, and the second optical member 22 including the polarization reflective layer R2 that reflects the image light ML passing through the wave plate 23, wherein the imaging optical system IS in which the first optical member 21, the wave plate 23, and the second optical member 22 are combined does not substantially have power for the left circularly polarized light c2 being a polarized component of the external light OL passing through the light transmission region A2 of the display 10a or 10b.

In the above virtual image display devices 100A, 100B, and the like, the image light ML being, for example, the right circularly polarized light cl passing through the reflective optical surface R1 passes through the wave plate 23 being a quarter-wave plate to become the vertically polarized light q1 being linearly polarized, is reflected by the polarization reflective layer R2, passes through the wave plate 23 again to become the original right circularly polarized light c1, and is partially reflected by the reflective optical surface R1. The image light ML reflected by the reflective optical surface R1 becomes the reversed left circularly polarized light c2, passes through the above wave plate 23 to become the horizontally polarized light q2 being linearly polarized in an intersecting direction, and passes through the polarization reflective layer R2. That is, the divergence state of the image light ML is adjusted in two stages by the reflection at the reflective optical surface R1 and the polarization reflective layer R2, and an image formed on the display surface 11d of the display 10a or 10b can be observed as a highly accurate virtual image. Note that the external light OL includes random polarized components, passes through the display 10a, 10b, or the reflective optical surface R1, becomes the horizontally polarized light q2 being linearly polarized in an intersecting direction when passing through the wave plate 23, and passes through the polarization reflective layer R2. At this time, the external light OL passes through the imaging optical system IS without being substantially subjected to a lens action by the first optical member 21, the wave plate 23, and the second optical member 22. That is, see-through viewing of an external world image while observing a virtual image via the imaging optical system IS is enabled.

### Second Embodiment

Below, a virtual image display device and the like of a second embodiment will be described. Note that the virtual image display device of the second embodiment is provided by partially modifying the virtual image display device of the first embodiment. Thus, explanation of portions common to the virtual image display device of the first embodiment will not be repeated.

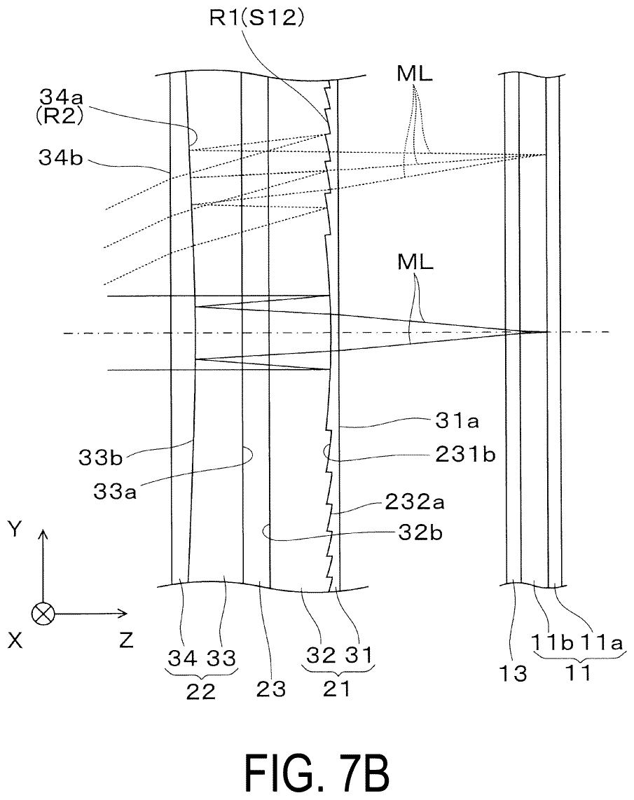

FIG. 7A is a side cross-sectional view for describing the first display optical system 20a incorporated in the virtual image display device of the second embodiment, and FIG. 7B is a partially enlarged view of a center of the first display optical system 20a. The first display optical system 20a, that is, the imaging optical system IS includes a first optical member 21 including a reflective optical surface R1 having power inside thereof, a wave plate 23 that converts a polarization state of the image light ML to be linearly polarized or circularly polarized, and a second optical member 22 including a polarization reflective layer R2.

A first emission surface 231b provided at the first lens element 31 and a second incident surface 232a provided at the second lens element 32 of the first optical member 21 are Fresnel-type optical surfaces, and are equivalent to the first emission surface 31b and the second incident surface 32a in the first optical member 21 of the first embodiment. Correspondingly, the reflective optical surface R1 incorporated in the first optical member 21 is also a Fresnel optical surface S12 having the same shape as that of the second incident surface 232a, and has the same power as that of the reflective optical surface R1 incorporated in the first optical member 21 of the first embodiment.

The first lens element 31 of the first optical member 21 is obtained by filling and flattening the second incident surface 232a of the second lens element 32 at which the Fresnel optical surface S12 is formed with an adhesive or a base material having the same refractive index as that of the second lens element 32. Conversely, the second lens element 32 may be obtained by filling and flattening the first emission surface 231b of the first lens element 31 at which the Fresnel optical surface S12 is formed with an adhesive or a base material having the same refractive index as that of the first lens element 31.

In the virtual image display device 100A or 100B of the embodiment, the reflective optical surface R1 is the Fresnel optical surface S12, and the first optical member 21 includes the first lens element 31 and the second lens element 32 that are joined to each other with the reflective optical surface R1 interposed therebetween. In this case, the first optical member 21 has a parallel plate shape as a whole and has the Fresnel optical surface S12 embedded therein. By using the Fresnel optical surface S12, the imaging optical system IS can be made more thinner.

In the embodiment, the thickness of the imaging optical system IS, that is, the distance from the first incident surface 31a of the first optical member 21 to the fourth emission surface 34b of the second optical member 22 is equal to or less than 7 mm, specifically, about 6.7 mm.

### Third Embodiment

Below, a virtual image display device and the like of a third embodiment will be described. Note that the virtual image display device of the third embodiment is a partial modification of the virtual image display device of the first embodiment.

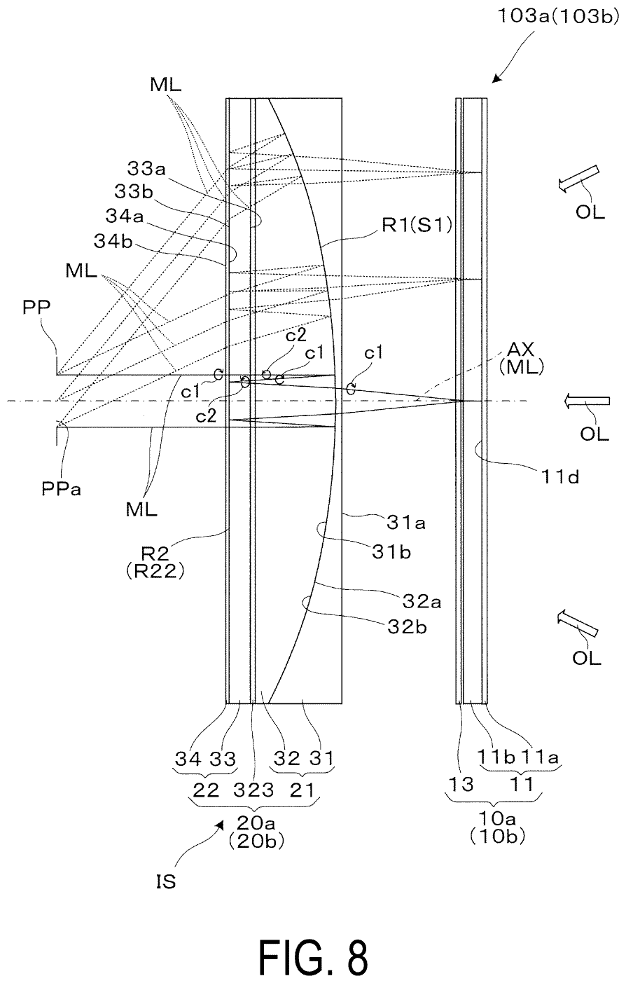

FIG. 8 is a side cross-sectional view for describing the first display optical system 20a incorporated in the virtual image display device of the third embodiment. The first display optical system 20a, that is, the imaging optical system IS includes the first optical member 21 having a plate shape and including the reflective optical surface R1 having power inside thereof, a wave plate 323 that converts a polarization state of the image light ML to be differently circularly polarized, and the second optical member 22 having a plate shape and including the polarization reflective layer R2 being a flat surface.

The wave plate 323 is a half-wave plate. The wave plate 323 is a member having a parallel plate shape as a whole, and does not have power as a whole for transmitted light.

In the second optical member 22, a cholesteric liquid crystal layer R22 is formed as the polarization reflective layer R2 above the third emission surface 33b of the third lens element 33. An external world side surface of the polarization reflective layer R2 is a flat surface having the same shape as that of the third emission surface 33b. The cholesteric liquid crystal layer R22 selectively reflects the image light ML passing through the wave plate 323 and becoming the left circularly polarized light c2, while maintaining a state of the left circularly polarized light c2.

The cholesteric liquid crystal layer R22 has a layered structure of molecules oriented in a certain direction, and molecular orientation axes between adjacent layers are twisted, so that orientation directions have a helical structure around a vertical axis of the layers as a whole. The cholesteric liquid crystal layer R22 is made of a predetermined liquid crystal material, and has a property of transmitting the right circularly polarized light c1 and reflecting the left circularly polarized light c2. The cholesteric liquid crystal layer R22 becomes a liquid crystal material layer in a stable state where fluidity is suppressed, by interposing a liquid crystal material including a liquid crystal material and additives between the third lens element 33 and the fourth lens element 34, and irradiating the interposed liquid crystal material with UV light or the like, or removing or vaporizing solvents from the interposed liquid crystal material, or heating the interposed liquid crystal material, in a state where the third lens element 33 and the fourth lens element 34 are relatively fixed. That is, the cholesteric liquid crystal layer R22 is formed by stabilizing the liquid crystal material. For example, the cholesteric liquid crystal layer R22 may be solidified above a surface of one of the third lens element 33 and the fourth lens element 34, and another of the third lens element 33 and the fourth lens element 34 may be affixed to sandwich the cholesteric liquid crystal layer R22. Note that as for manufacturing of the cholesteric liquid crystal layer R22, methods described in JP 2008-501147 T and JP 2021-532393 T can be applied. By rotating an orientation of liquid crystal with respect to an optical axis during fabrication, the cholesteric liquid crystal layer R22 can reflect only circularly polarized light on one side and apply power at the time of reflection. That is, despite the fact that the cholesteric liquid crystal layer R22 itself is a flat surface, the cholesteric liquid crystal layer R22 can have a lens effect on the cholesteric liquid crystal layer R22 for the image light ML reflected thereby.

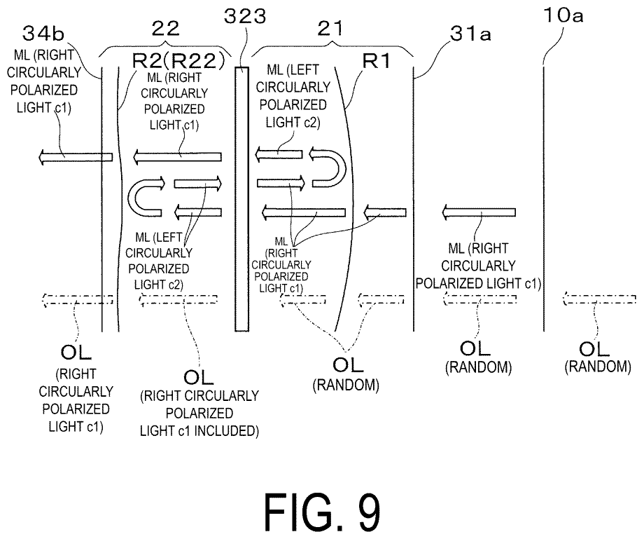

Referring to FIG. 9, in the above virtual image display devices 100A, 100B, and the like, the image light ML of, for example, the right circularly polarized light cl passing through the reflective optical surface R1 passes through the wave plate 323 being a half-wave plate to become the left circularly polarized light c2 being circularly polarized, is reflected by the polarization reflective layer R2, passes through the wave plate 323 again to become the original right circularly polarized light c1, and is partially reflected by the reflective optical surface R1. The image light ML reflected by the reflective optical surface R1 becomes the reversed left circularly polarized light c2, passes through the above wave plate 323 to become the right circularly polarized light c1 being originally circularly polarized, and passes through the polarization reflective layer R2. That is, the divergence state of the image light ML is adjusted in two stages by the reflection at the reflective optical surface R1 and the polarization reflective layer R2, and an image formed on the display surface 11d of the display 10a or 10b can be observed as a highly accurate virtual image. Note that the external light OL includes random polarized components, passes through the display 10a, 10b, or the reflective optical surface R1, and when the external light OL passes through the wave plate 323, the left circularly polarized light c2 becomes the right circularly polarized light c1 and passes through the polarization reflective layer R2. At this time, the external light passes through the imaging optical system IS without being substantially subjected to a lens action by the first optical member 21, the wave plate 323, and the second optical member 22. That is, see-through viewing of an external world image via the imaging optical system IS is enabled.

Although detailed description is omitted, the polarizing element 11q can be added to the display panel 11 in the same manner as in the modification illustrated in FIG. 3C of the first embodiment. Accordingly, only the left circularly polarized light c2 can be made incident on the first display optical system 20a, that is, the imaging optical system IS.

In addition, the first display 10a may also be one that emits the image light ML being the left circularly polarized light c2. In this case, the polarization reflective layer R2 is the cholesteric liquid crystal layer R22 that transmits left circularly polarized light c2 and reflects right circularly polarized light c1.

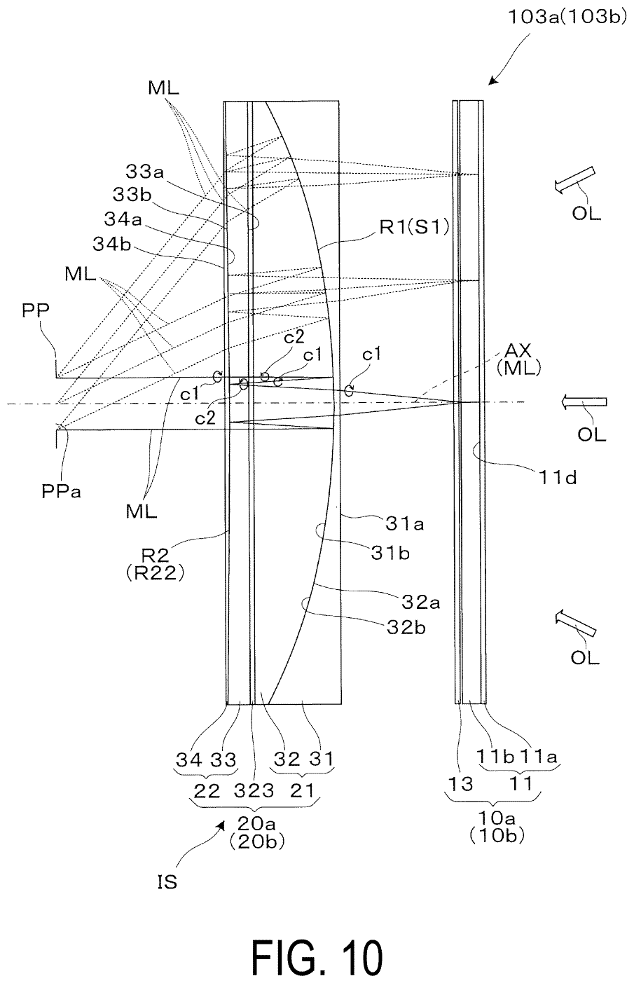

FIG. 10 is a diagram for describing a modification of the first display optical system 20a illustrated in FIG. 1. In this case, the polarization reflective layer R2 is not a flat surface but a curved surface such as an aspherical surface, for example, and the cholesteric liquid crystal layer R22 is provided along the curved surface. Note that the polarization reflective layer R2 is not limited to the illustrated curved surface, and may be formed into various curved surfaces in consideration of aberration correction and power.

### Fourth Embodiment

A virtual image display device of a fourth embodiment will be described below. Note that the virtual image display device of the fourth embodiment is a partial modification of the virtual image display device of the third embodiment.

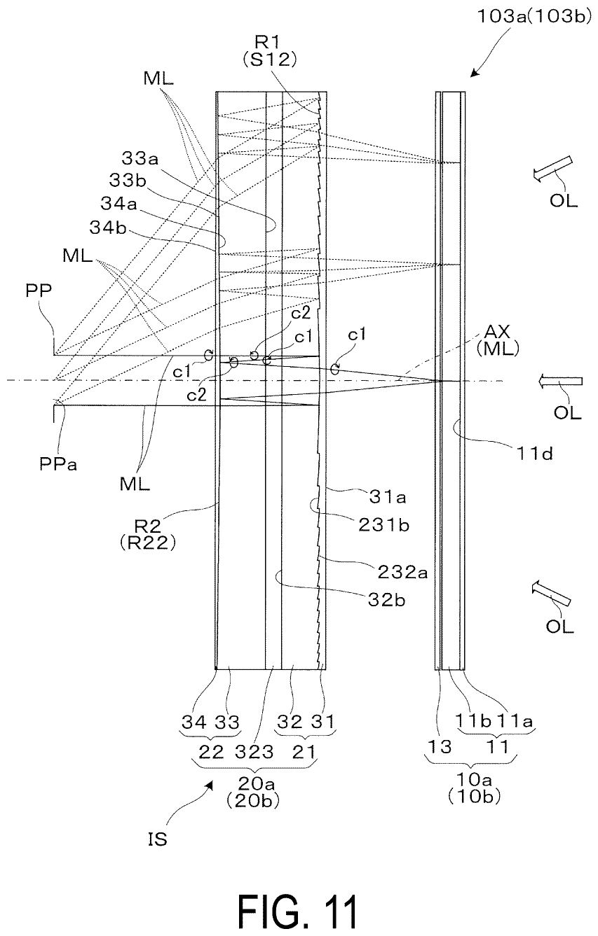

FIG. 11 is a side cross-sectional view for describing the first display optical system 20a incorporated in the virtual image display device of the fourth embodiment. The first display optical system 20a, that is, the imaging optical system IS includes, as in the third embodiment, the first optical member 21 including the reflective optical surface R1 having power inside thereof, the wave plate 323 that converts a polarization state of the image light ML to be differently circularly polarized, and the second optical member 22 including the polarization reflective layer R2.

The first emission surface 231b provided at the first lens element 31 and the second incident surface 232a provided at the second lens element 32 of the first optical member 21 are Fresnel-type optical surfaces, and are equivalent to the first emission surface 31b and the second incident surface 232a of the first optical member 21 of the third embodiment. Correspondingly, the reflective optical surface R1 incorporated in the first optical member 21 is also the Fresnel optical surface S12 having the same shape as the second incident surface 32b, and has the same power as the reflective optical surface R1 incorporated in the first optical member 21 of the third embodiment.

In the virtual image display device 100A or 100B of the embodiment, the reflective optical surface R1 is the Fresnel optical surface S12, and the first optical member 21 includes the first lens element 31 and the second lens element 32 that are joined to each other with the reflective optical surface R1 interposed therebetween. In this case, the first optical member 21 has a parallel plate shape as a whole and has the Fresnel optical surface S12 embedded therein.

The first lens element 31 of the first optical member 21 is obtained by, for example, filling and flattening the second incident surface 232a of the second lens element 32 at which the Fresnel optical surface S12 is formed with an adhesive or a base material having the same refractive index as that of the second lens element 32.

In the embodiment, the thickness of the imaging optical system IS, that is, the distance from the first incident surface 31a of the first optical member 21 to the fourth emission surface 34b of the second optical member 22 is equal to or less than 7 mm, specifically, about 6.3 mm.

### Modification Examples and Others

These are descriptions of the present disclosure with reference to the embodiments. However, the present disclosure is not limited to the embodiments described above. It is possible to implement the present disclosure in various modes without departing from the spirit of the disclosure. For example, the following modifications are possible.

Although it has been assumed above that the HMD 200 is worn on the head and is used, the virtual image display devices 100A and 100B may also be used as a hand-held display that is not worn on the head and is to be looked into like binoculars. In other words, in the present disclosure, the head-mounted display also includes a hand-held display.

In the embodiment described above, in the displays 10a and 10b, the arrangement and size of the pixel region A1 can be changed as appropriate as far as the sufficient light transmission region A2 is present.

A virtual image display device or an optical unit in a specific aspect includes, in an order from an external world, a display including a pixel region that emits circularly polarized image light, and configured to partially transmit external light, a first optical member having a flat surface on the display side and including a semi-transmissive reflective optical surface having power inside thereof, a wave plate configured to convert a polarization state of the image light passing through the first optical member to be linearly polarized or circularly polarized, and a second optical member including a polarization reflective layer that reflects the image light passing through the wave plate, wherein an imaging optical system in which the first optical member, the wave plate, and the second optical member are combined does not substantially have power for a polarized component of the external light passing through a light transmission region of the display.

In the above virtual image display device, the circularly polarized light image light passing through the reflective optical surface, for example, passes through a quarter-wave plate to be linearly polarized, and is reflected by the polarization reflective layer, passes through the wave plate again to be originally circularly polarized, and is partially reflected by the reflective optical surface. The image light reflected by the reflective optical surface is reversely circularly polarized, and passes through the above quarter-wave plate to be linearly polarized in an intersecting direction, and passes through the polarization reflective layer. That is, a divergence state of the image light is adjusted in two stages by the reflection at the reflective optical surface and the polarization reflective layer, and an image formed on a display surface of the display can be observed as a highly accurate virtual image. In addition, the image light of the circularly polarized light passing through the reflective optical surface, for example, passes through a half-wave plate to be reversely circularly polarized, and is reflected by the polarization reflective layer, passes through the wave plate again to be originally circularly polarized, and is partially reflected by the reflective optical surface. The image light reflected by the reflective optical surface is reversely circularly polarized, and passes through the above half-wave plate to be originally circularly polarized, and passes through the polarization reflective layer. That is, a divergence state of the image light is adjusted in two stages by the reflection at the reflective optical surface and the polarization reflective layer, and an image formed on a display surface of the display can be observed as a highly accurate virtual image. Note that the external light includes random polarized components, passes through the display, or the reflective optical surface, is linearly polarized in an intersecting direction or reversely circularly polarized when passing through the wave plate, and passes through the polarization reflective layer. At this time, the external light passes through the imaging optical system without being substantially subjected to a lens action by the first optical member, the wave plate, and the second optical member. That is, see-through viewing of an external world image via the imaging optical system is enabled.

In the virtual image display device in a specific aspect, a thickness of the imaging optical system from the first optical member to the second optical member is equal to or less than 7 mm. By setting the thickness of the imaging optical system to be equal to or less than 7 mm, it is possible to reduce the virtual image display device or the optical unit in weight. At this time, since the divergence state is adjusted with high accuracy by the reflection at the reflective optical surface and the polarization reflective layer, resolution can be enhanced and color unevenness can be reduced.

In the virtual image display device in a specific aspect, the reflective optical surface is a continuous curved surface, and the first optical member includes a first lens element and a second lens element that are joined to each other with the reflective optical surface interposed therebetween. In this case, the first optical member is like a joined lens having a parallel plate shape as a whole and having a continuous reflective optical surface embedded therein.

In the virtual image display device in a specific aspect, the reflective optical surface is a Fresnel optical surface, and the first optical member includes a first lens element and a second lens element that are joined to each other with the reflective optical surface interposed therebetween. In this case, the first optical member has a parallel plate shape as a whole and has the Fresnel optical surface embedded therein.

In the virtual image display device in a specific aspect, the polarization reflective layer is a continuous curved surface, and the first optical member includes a third lens element and a fourth lens element that are joined to each other with the polarization reflective layer interposed therebetween. In this case, the second optical member is like a joined lens having a parallel plate shape as a whole and having a continuous polarization reflective layer embedded therein.

In the virtual image display device in a specific aspect, the wave plate is a quarter-wave plate, and the polarization reflective layer is a reflective polarizer. That is, the image light of the circularly polarized light passing through the reflective optical surface passes through the quarter-wave plate to be linearly polarized, and is reflected by the polarization reflective layer, passes through the wave plate again to be originally circularly polarized, and is partially reflected by the reflective optical surface. The image light reflected by the reflective optical surface is reversely circularly polarized, and passes through the above quarter-wave plate to be linearly polarized in an intersecting direction, and passes through the polarization reflective layer.

In the virtual image display device in a specific aspect, the wave plate is a half-wave plate, and the polarization reflective layer is a cholesteric liquid crystal layer. That is, the circularly polarized image light passing through the reflective optical surface passes through the half-wave plate to be reversely circularly polarized, and is reflected by the polarization reflective layer, passes through the wave plate again to be originally circularly polarized, and is partially reflected by the reflective optical surface. The image light reflected by the reflective optical surface is reversely circularly polarized, and passes through the above half-wave plate to be originally circularly polarized, and passes through the polarization reflective layer.

In the virtual image display device in a specific aspect, the cholesteric liquid crystal layer is formed above a flat surface.

In the virtual image display device in a specific aspect, the cholesteric liquid crystal layer is formed by stabilizing a liquid crystal material.

In the virtual image display device in a specific aspect, the display individually includes a pixel region that brocks transmission of external light, and a light transmission region that has optical transparency for the external light. The external light passes through the light transmission region without being affected by the pixel region, is incident on the imaging optical system, and also passes through the imaging optical system.

What is claimed is:

1. A virtual image display device, comprising:
in an order from an external world,
a display including a pixel region that emits circularly polarized image light, and configured to partially transmit external light;
a first optical member having a flat surface on the display side and including a semi-transmissive reflective optical surface having power inside thereof;
a wave plate configured to convert a polarization state of the image light passing through the first optical member to be linearly polarized or circularly polarized; and
a second optical member including a polarization reflective layer that reflects the image light passing through the wave plate, wherein
an imaging optical system in which the first optical member, the wave plate, and the second optical member are combined does not substantially have power for a polarized component of the external light passing through a light transmission region of the display.

2. The virtual image display device according to claim 1, wherein
a thickness of the imaging optical system from the first optical member to the second optical member is equal to or less than 7 mm.

3. The virtual image display device according to claim 1, wherein
the reflective optical surface is a continuous curved surface, and
the first optical member includes a first lens element and a second lens element that are joined to each other with the reflective optical surface interposed therebetween.

4. The virtual image display device according to claim 1, wherein
the reflective optical surface is a Fresnel optical surface, and
the first optical member includes a first lens element and a second lens element that are joined to each other with the reflective optical surface interposed therebetween.

5. The virtual image display device according to claim 1, wherein
the polarization reflective layer is a continuous curved surface, and
the first optical member includes a third lens element and a fourth lens element that are bonded to each other with the polarization reflective layer interposed therebetween.

6. The virtual image display device according to claim 1, wherein
the wave plate is a quarter-wave plate, and
the polarization reflective layer is a reflective polarizer.

7. The virtual image display device according to claim 1, wherein
the wave plate is a half-wave plate, and
the polarization reflective layer is a cholesteric liquid crystal layer.

8. The virtual image display device according to claim 7, wherein
the cholesteric liquid crystal layer is formed above a flat surface.

9. The virtual image display device according to claim 7, wherein
the cholesteric liquid crystal layer is formed by stabilizing a liquid crystal material.

10. The virtual image display device according to claim 1, wherein
the display individually includes the pixel region that blocks transmission of the external light, and
the light transmission region having optical transparency for the external light.

11. An optical unit, comprising:
in an order from an external world,
a display including a pixel region that emits circularly polarized image light, and configured to partially transmit external light;
a first optical member having a flat surface on the display side and including a semi-transmissive reflective optical surface having power inside thereof;
a wave plate configured to convert a polarization state of the image light passing through the first optical member to be linearly polarized or circularly polarized; and
a second optical member including a polarization reflective layer that reflects the image light passing through the wave plate, wherein
an imaging optical system in which the first optical member, the wave plate, and the second optical member are combined does not substantially have power for a polarized component of the external light passing through a light transmission region of the display.
